(19) United States
(12) Patent Application Publication
(10) Pub. No.: US 2025/0166564 A1
(43) Pub. Date: May 22, 2025

(54) DISPLAY DEVICE AND METHOD OF DRIVING THE SAME

(71) Applicant: Samsung Display Co., LTD., Yongin-si (KR)

(72) Inventors: Sang Hyun KANG, Yongin-si (KR); Do Hyun KANG, Yongin-si (KR); Oh Chul KWON, Yongin-si (KR); Pan Ju KIM, Yongin-si (KR); Byung Kwan SONG, Yongin-si (KR); Joo Sun YOON, Yongin-si (KR); Sang Myoung LEE, Yongin-si (KR); Joon HUH, Yongin-si (KR)

(21) Appl. No.: 18/916,447

(22) Filed: Oct. 15, 2024

(30) Foreign Application Priority Data
Nov. 22, 2023 (KR) 10-2023-0163721

(51) Int. Cl. G09G 3/3233

(52) U.S. Cl. CPC G09G 3/3233; G09G 2300/0819; G09G 2300/0852; G09G 2320/0233; G09G 2320/041

(57) ABSTRACT

A display device includes pixels connected to scan lines, data lines, and emission control lines, a start signal generator configured to generate a first start signal corresponding to a first emission control signal supplied in a write period of a frame period, in which a data signal is supplied, and a second start signal corresponding to a second emission control signal supplied in a maintenance period of the frame period, in which the data signal is maintained, and having a width that is different from a width of the first start signal, a selector configured to supply the first start signal or the second start signal based on a control signal from a controller, and an emission driver configured to supply the first emission control signal or the second emission control signal to the emission control lines based on the first start signal or the second start signal.

### CROSS-REFERENCE TO RELATED APPLICATION

The present application claims priority to, and the benefit of, Korean patent application No. 10-2023-0163721, filed on Nov. 22, 2023, in the Korean Intellectual Property Office, the entire disclosure of which is incorporated herein by reference.

### BACKGROUND

### 1. Field

The present disclosure generally relates to a display device, and a method of driving the same.

### 2. Description of the Related Art

With the development of information technologies, the importance of a display device, which is a connection medium between a user and information, increases. Accordingly, display devices, such as a liquid crystal display device and an organic light-emitting display device, are increasingly used.

Recent display devices provide a high-speed driving function of providing users with images changed at a high frame frequency, and a low-speed driving function of providing users with images changed at a low frame frequency. To this end, one frame may include a write period in which a data signal is supplied, and at least one maintenance period in which light is emitted while maintaining the data signal. When a luminance difference occurs between the write period and the maintenance period, display quality may be deteriorated.

### SUMMARY

Embodiments provide a display device, and a method of driving the same, which can reduce or minimize a luminance difference between a write period and a maintenance period, which are included in one frame period.

In accordance with an aspect of the present disclosure, there is provided a display device including pixels connected to scan lines, data lines, and emission control lines, a start signal generator configured to generate a first start signal corresponding to a first emission control signal supplied in a write period of a frame period, in which a data signal is supplied, and a second start signal corresponding to a second emission control signal supplied in a maintenance period of the frame period, in which the data signal is maintained, and having a width that is different from a width of the first start signal, a selector configured to supply the first start signal or the second start signal based on a control signal from a controller, and an emission driver configured to supply the first emission control signal or the second emission control signal to the emission control lines based on the first start signal or the second start signal.

The first start signal may include a sub-first start signal and a sub-second start signal, wherein a time at which supply of the sub-second start signal is suspended after the sub-first start signal is supplied is the width of the first start signal.

The selector may be configured to supply the first start signal to the emission driver during the write period, and to supply the second start signal to the emission driver during the maintenance period.

The widths of the first start signal and the second start signal may be set such that light is generated in the pixels during the write period and the maintenance period to have a luminance difference equal to or less than a threshold value.

The widths of the first start signal and the second start signal may be set such that the pixels emit light for a longer time during the write period as compared with the maintenance period.

The widths of the first start signal and the second start signal may be set such that the pixels emit light for a shorter time during the write period as compared with the maintenance period.

The display device may further include a temperature sensor configured to sense a temperature of the display device, wherein the start signal generator is configured to change a width of the first start signal or the second start signal.

The display device may further include a timing controller configured to control the emission driver, and including the start signal generator, the controller, and the selector.

The emission driver may include the selector.

A pixel among the pixels may include a light-emitting element for generating light corresponding to an amount of current flowing from a first power line, to which a first electrode is connected, to a second power line, to which a second electrode is connected, a first transistor connected between the first electrode of the light-emitting element and the first power line, and configured to control the amount of current corresponding to a voltage of a first node, a second transistor connected between one of the data lines and the first node, and including a gate electrode connected to a first scan line, a third transistor connected between the first transistor and the first electrode of the light-emitting element, and including a gate electrode connected to a fourth scan line, a fourth transistor connected between the first electrode of the light-emitting element and a third power line to which an initialization power source is supplied, and including a gate electrode connected to a second scan line, a fifth transistor connected between a fourth power line to which a reference power source is supplied and the first node, and including a gate electrode connected to a third scan line, a sixth transistor connected between the first power line and the first transistor, and including a gate electrode connected to an emission control line, a first capacitor connected between the first node and a second node as a common node between the first transistor and the third transistor, and a second capacitor connected between the first power line and the second node, and wherein the first transistor, the second transistor, the third transistor, the fourth transistor, the fifth transistor, and the sixth transistor include N-type transistors.

The first transistor may include a first gate electrode connected to the first node, and a second gate electrode connected to the second node.

The start signal generator may be configured to change the widths of the first start signal or the second start signal, corresponding to a dimming level.

The start signal generator may be configured to supply the first start signal or the second start signal to the selector during the write period or the maintenance period.

The start signal generator may be configured to supply the first start signal or the second start signal to the selector during the write period, and supply the second start signal to the selector during the maintenance period.

In accordance with another aspect of the present disclosure, there is provided a method of driving a display device, the method including supplying, by an emission driver, a first emission control signal based on a first start signal during a write period of a frame period in which a data signal is supplied, and supplying, by the emission driver, a second emission control signal based on a second start signal for a maintenance period of the frame period in which the data signal is maintained, wherein a first emission period of the write period, which corresponds to the first emission control signal, and a second emission period of the maintenance period, which corresponds to the second emission control signal, have different widths.

The method may further include generating the first start signal and the second start signal, supplying the first start signal to the emission driver during the write period, using a selector, and supplying the second start signal to the emission driver during the maintenance period, using the selector.

Widths of the first start signal and the second start signal may be set such that light is generated during the first emission period and the second emission period with a luminance difference equal to or less than a threshold value.

The second emission period may be longer than the first emission period.

The first emission period may be longer than the second emission period.

The method may further include sensing a temperature of the display device, and changing a width of the first start signal or the second start signal based on the temperature.

### BRIEF DESCRIPTION OF THE DRAWINGS

Embodiments will now be described more fully hereinafter with reference to the accompanying drawings. However, they may be embodied in different forms, and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a display device in accordance with one or more embodiments of the present disclosure.

FIG. 2 is a diagram illustrating one or more embodiments of a scan driver and an emission driver, which are shown in FIG. 1.

FIG. 3 is a diagram illustrating a pixel in accordance with one or more embodiments of the present disclosure.

FIG. 4 is a diagram illustrating one or more embodiments of a method of driving the pixel shown in FIG. 3 during a write period.

FIG. 5 is a diagram illustrating one or more embodiments of the method of driving the pixel shown in FIG. 3 during a maintenance period.

FIGS. 6A and 6B are diagrams illustrating luminances of the pixel during the write period and the maintenance period.

FIG. 7 is a diagram illustrating a timing controller in accordance with one or more embodiments of the present disclosure.

FIG. 8 is a diagram illustrating an emission driver in accordance with one or more embodiments of the present disclosure.

FIG. 9 is a diagram illustrating a first start signal and a second start signal when the write period is brighter than the maintenance period.

FIGS. 10A and 10B are diagrams illustrating embodiments in which the first start signal is supplied.

FIG. 11 is a diagram illustrating the first start signal and the second start signal when the maintenance period is brighter than the write period.

FIG. 12 is a diagram illustrating luminances of the write period and the maintenance period in accordance with one or more embodiments of the present disclosure.

FIGS. 13A and 13B are diagrams illustrating an emission control signal in accordance with one or more embodiments of the present disclosure.

FIG. 14 is a diagram of a timing controller in accordance with one or more embodiments of the present disclosure.

FIG. 15 is a diagram illustrating luminances corresponding temperatures of the display device.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

It will be understood that when an element, layer, region, or component is referred to as being “connected to” another element, layer, region, or component, it can be directly connected to the other element, layer, region, or component, or indirectly connected to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” to another layer, region, or component, it can be directly electrically connected to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected” refers to one component directly connecting another component without an intermediate component.

In addition, expressions describing relationships between components, such as “between,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

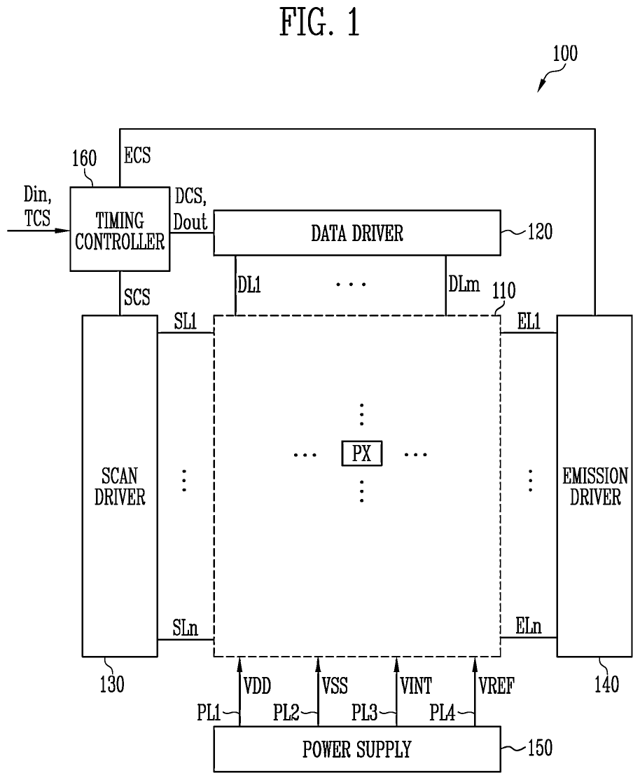

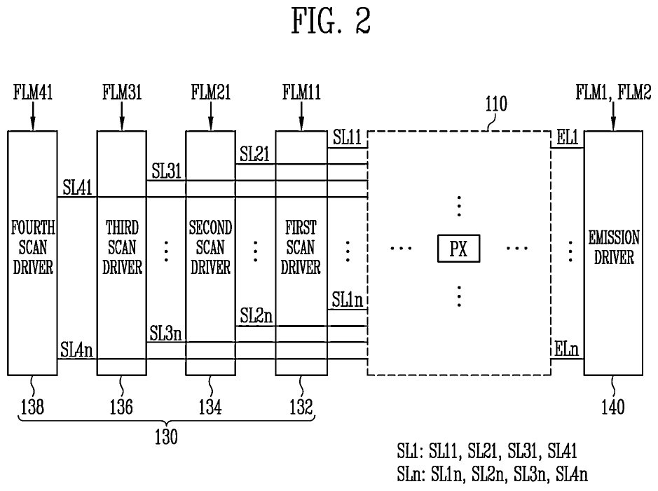

FIG. 1 is a diagram illustrating a display device in accordance with one or more embodiments of the present disclosure. FIG. 2 is a diagram illustrating one or more embodiments of a scan driver and an emission driver, which are shown in FIG. 1.

Referring to FIG. 1, the display device 100 in one or more embodiments may include a pixel unit 110 (or display panel), a data driver 120, a scan driver 130, an emission driver 140, a power supply 150, and a timing controller 160.

The display device 100 may display an image at various image refresh rates (e.g., driving frequencies or screen refresh rates) according to driving conditions. The image refresh rate means a frequency at which a data signal is written to a driving transistor of a pixel PX. For example, the image refresh rate may also be referred to as a screen scan rate or a screen refresh frequency, and may represent a frequency at which a display screen is reproduced for one second.

In one or more embodiments, an output frequency of the data driver 120 with respect to one horizontal line (e.g., pixels PX connected to the same scan line may be sorted as one horizontal line, or one pixel row), and/or an output frequency of the scan driver 130 that outputs a scan signal, may be determined corresponding to the image refresh rate.

For example, one scan line (each of SL1 to SLn) shown in FIG. 1 may include four scan lines as shown in FIG. 2. That is, a scan line SL1 may include a first scan line SL11, a second scan line SL21, a third scan line SL31, and a fourth scan line SL41. A scan line SLn may include a first scan line SL1n, a second scan line SL2n, a third scan line SL3n, and a fourth scan line SL4n. A frequency of a first scan signal (or write scan signal) output from a first scan driver 132 may be determined by the image refresh rate.

An image refresh rate for driving a moving image may be a frequency of about 60 Hz or higher (e.g., about 120 Hz, about 240 Hz, or the like). For example, the display device 100 may display an image, corresponding to various image refresh rates of about 1 Hz to about 240 Hz. However, this is merely illustrative, and the display device 100 may also display an image at an image refresh rate of amount 240 Hz or higher (e.g., about 480 Hz).

The pixel unit 110 may include pixels PX connected to scan lines SL1 to SLn, data lines DL1 to DLm, emission control lines EL1 to ELn, and power lines PL1, PL2, PL3, and PL4 (n and m being natural numbers of 2 or more).

The pixels PX may be selected in units of horizontal lines when an enable first scan signal is supplied to the first scan lines SL11 to SL1n, and each of the pixels PX selected by the enable first scan signal may be supplied with a data signal from a data line (any one of DL1 to DLm) connected thereto. The pixel PX supplied with the data signal may generate light with a luminance (e.g., predetermined luminance) corresponding to a voltage of the data signal.

The scan driver 130 may receive a scan-driving signal SCS from the timing controller 160. At least one scan start signal and/or clock signals, which are suitable for driving of the scan driver 130, may be included in the scan-driving signal SCS. The scan driver 130 may generate the enable first scan signal, an enable second scan signal, an enable third scan signal, and an enable fourth scan signal while shifting the scan start signal, which corresponds to the clock signal.

To this end, the scan driver 130 may include a first scan driver 132, the second scan driver 134, a third scan driver 136, and a fourth scan driver 138, as shown in FIG. 2. At least some of the scan drivers 132, 134, 136, and 138 may be integrated into one driving circuit, one module, or the like according to a design.

The first scan driver 132 may receive a first scan start signal FLM11, and may generate the enable first scan signal while shifting the first scan start signal FLM11, corresponding to (e.g., based on) the clock signal. The first scan driver 132 may sequentially supply the enable first scan signal to the first scan lines SL11 to SL1n. In one or more embodiments, the first scan driver 132 may supply the enable first scan signal during a write period in an active area of one frame.

The second scan driver 134 may receive a second scan start signal FLM21, and may generate the enable second scan signal while shifting the second scan start signal FLM21, corresponding to the clock signal. The second scan driver 134 may sequentially supply the enable second scan signal to second scan lines SL21 to SL2n. In one or more embodiments, the second scan driver 134 may supply the enable second scan signal during the write period in the active area of the one frame. In one or more embodiments, the second scan driver 134 may supply the enable second scan signal during a maintenance period included in the active area and a blank area of the one frame.

For example, the second scan driver 134 may perform scanning once during the write period of the one frame (e.g., may supply at least one enable second scan signal), and may perform scanning at least once according to the image refresh rate during the maintenance period of the one frame. When the image refresh rate is decreased (e.g., when a frame length is lengthened), the blank area of the one frame may be lengthened, and hence a number of maintenance periods included in the blank area may be increased. That is, when the image refresh rate is decreased, a number of times an operation of supplying the enable second scan signal is repeated may be increased.

The third scan driver 136 may receive a third scan start signal FLM31, and may generate the enable third scan signal while shifting the third scan start signal FLM31, corresponding to the clock signal. The third scan driver 136 may sequentially supply the enable third scan signal to third scan lines SL31 to SL3n. In one or more embodiments, the third scan driver 136 may supply the enable third scan signal during the write period in the active area of the one frame.

The fourth scan driver 138 may receive a fourth scan start signal FLM41, and may generate the enable fourth scan signal while shifting the fourth scan start signal FLM41, corresponding to the clock signal. The fourth scan driver 138 may sequentially supply the enable fourth scan signal to fourth scan lines SL41 to SL4n. In one or more embodiments, the fourth scan driver 138 may supply the enable fourth scan signal during the write period in the active area of the one frame.

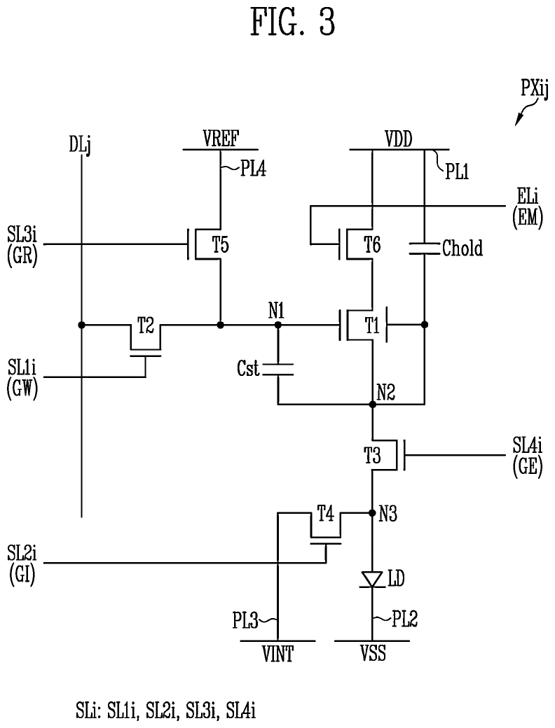

Each of the enable first scan signal, the enable second scan signal, the enable third scan signal, and the enable fourth scan signal may be set to a gate-on voltage such that transistors included in the pixels PX can be turned on. For example, each of an enable first scan signal, an enable second scan signal, an enable third scan signal, and an enable fourth scan signal, which are supplied to an N-type transistor as shown in FIG. 3, may be set to a high level voltage.

The data driver 120 may receive output data Dout and a data-driving signal DCS from the timing controller 160. The data-driving signal DCS may include a sampling signal and/or timing signals suitable for driving of the data driver 120. The data driver 120 may generate a data signal, based on the data-driving signal DCS and the output data Dout. For example, the data driver 120 may generate an analog data signal based on a grayscale of the output data Dout. The data driver 120 may supply the data signal in one horizontal period unit.

The emission driver 140 may receive an emission-driving signal ECS from the timing controller 160. A start signal and clock signals, which are suitable for driving the emission driver 140, may be included in the emission-driving signal ECS. The emission driver 140 may generate a disable emission control signal while shifting the start signal corresponding to the clock signal.

In one or more embodiments, the start signal may include a first start signal FLM1 and a second start signal FLM2 as shown in FIG. 2. The first start signal FLM1 may be a signal for supplying a disable emission control signal (or first emission control signal) in the write period, and the second start signal FLM2 may be a signal for supplying a disable emission control signal (or second emission control signal) in the maintenance period. The first start signal FLM1 and the second start signal FLM2 may have different widths. This will be described in detail later with reference to FIGS. 7 to 15.

The emission driver 140 may generate the disable emission control signal while shifting the start signal FLM1 or FLM2 corresponding to the clock signal. The emission driver 140 may sequentially supply the disable emission control signal to the emission control lines EL1 to ELn. The disable emission control signal may be set to a gate-off voltage, such that the transistors included in the pixels PX can be turned off. For example, a disable emission control signal supplied to the N-type transistor as shown in FIG. 3 may be set to a low level voltage.

In one or more embodiments, the emission driver 140 may supply the disable emission control signal during the write period and the maintenance period of the one frame. For example, the emission driver 140 may perform scanning at least once during the write period of the one frame, and may perform scanning at least once according to the image refresh rate during the maintenance period of the one frame. When the image refresh rate is decreased (e.g., when the frame length is lengthened), the blank area of the one frame is lengthened, and hence the number of maintenance periods included in the blank area may be increased. That is, when the image refresh rate is decreased, a number of times an operation of supplying the disable emission control signal is repeated may be increased.

The timing controller 160 may receive input data Din and a timing control signal TCS from a host system through an interface. For example, the timing controller 160 may receive the input data Din and the timing control signal TCS from at least one of a Graphics Processing Unit (GPU), a Central Processing Unit (CPU), or an Application Processor (AP), which may be included in the host system. Various signals including a clock signal may be included in the timing control signal TCS.

The timing controller 160 may generate the scan-driving signal SCS, the data-driving signal DCS, and the emission-driving signal ECS, based on the timing control signal TCS. The scan-driving signal SCS, the data-driving signal DCS, and the emission-driving signal ECS may be supplied to the scan driver 130, the data driver 120, and the emission driver 140, respectively.

The timing controller 160 may realign the input data Din to be suitable for specifications of the display device 100. Also, the timing controller 160 may generate the output data Dout by correcting the input data Din, and may supply the output data Dout to the data driver 120. In one or more embodiments, the timing controller 160 may correct the input data Din corresponding to an optical measurement result measured in a processing process.

The power supply 150 may generate various power sources suitable for driving of the display device 100. For example, the power supply 150 may generate a first driving power source VDD, a second driving power source VSS, an initialization power source VINT, and a reference power source VREF.

The first driving power source VDD may be a power source that supplies a driving current to the pixels PX. The second driving power source VSS may be a power source that is supplied with the driving current from the pixels PX. The first driving power source VDD may be set to a voltage that is higher than a voltage of the second driving power source VSS during a period in which the pixels PX are in an emission state.

The initialization power source VINT may be a power source that initializes a gate electrode of a driving transistor and a first electrode (or anode electrode) of a light-emitting element, which are included in each of the pixels. The reference power source VREF may be a power source that is supplied to the gate electrode of the driving transistor included in each of the pixels.

The first driving power source VDD generated by the power supply 150 may be supplied to a first power line PL1, the second driving power source VSS generated by the power supply 150 may be supplied to a second power line PL2, the initialization power source VINT generated by the power supply 150 may be supplied to a third power line PL3, and the reference power source VREF generated by the power supply 150 may be supplied to a fourth power line PL4. The first power line PL1, the second power line PL2, the third power line PL3, and the fourth power line PL4 may be commonly connected to the pixels PX, but the present disclosure is not limited thereto.

In one or more embodiments, the first power line PL1 may be configured with a plurality of power lines, and the plurality of power lines may be connected to different pixels PX. In one or more embodiments, the second power line PL2 may be configured with a plurality of power lines, and the plurality of power lines may be connected to different pixels PX. In one or more embodiments, the third power line PL3 may be configured with a plurality of power lines, and the plurality of power lines may be connected to different pixels PX. In one or more embodiments, the fourth power line PL4 may be configured with a plurality of power lines, and the plurality of power lines may be connected to different pixels PX.

In one or more embodiments of the present disclosure, the display device 100 may include a flat display device, a curved display device in which a portion of the pixel unit 110 is curved, a flexible display device in which a portion of the pixel unit 110 is folded or bent, and a stretchable display device in which a portion of the pixel unit 110 is expanded/contracted.

In one or more embodiments of the present disclosure, the display device is a device that displays moving images or still images, and may include portable electronic devices, such as a mobile phone, a smartphone, a tablet personal computer (PC), a smart watch, a watch phone, a portable multimedia player (PMP), a navigation system, and an ultra-mobile computer (UMPC). In one or more embodiments of the present disclosure, the display device 100 may include electronic devices, such as a television, a notebook computer, a monitor, an advertisement board, and Internet of things (IoT).

FIG. 3 is a diagram illustrating a pixel in accordance with one or more embodiments of the present disclosure. In FIG. 3, a pixel PXij located at an ith horizontal line and a jth vertical line is illustrated.

Referring to FIG. 3, the pixel PXij in one or more embodiments may be connected to corresponding signal lines SLi, DLj, and ELi. For example, the pixel PXij may be connected to an ith scan line SLi, an ith emission control line ELi, and a jth data line DLj (i being a natural number of n or less, and j being a natural number of m or less). The ith scan line SLi may include a plurality of scan lines SL1i, SL2i, SL3i, and SL4i. The pixel PXij may be further connected to the power lines PL1, PL2, PL3, and PL4.

The pixel PXij may include a light-emitting element LD, and a pixel circuit for controlling an amount of current supplied to the light-emitting element LD.

The light-emitting element LD may be connected between the first power line PL1 and the second power line PL2. For example, a first electrode (e.g., an anode electrode) of the light-emitting element LD may be connected to the first power line PL1 via a third node N3, a third transistor T3, a second node N2, a first transistor T1, and a sixth transistor T6. A second electrode (e.g., a cathode electrode) of the light-emitting element LD may be connected to the second power line PL2. The light-emitting element LD may generate light with a luminance corresponding to an amount of current supplied from the pixel circuit.

The light-emitting element LD may be selected as an organic light-emitting diode. Also, the light-emitting element LD may be selected as an inorganic light-emitting diode, such as a micro LED (light-emitting diode) or a quantum dot light-emitting diode. Also, the light-emitting element LD may be an element configured with a combination of an organic material and an inorganic material. In FIG. 3, it is illustrated that the pixel PXij includes a single light-emitting element LD. However, in one or more other embodiments, the pixel PXij may include a plurality of light-emitting elements LD, and the plurality of light-emitting elements LD may be connected in series, parallel or series/parallel to each other.

The pixel circuit may include the first transistor T1, a second transistor T2, the third transistor T3, a fourth transistor T4, a fifth transistor T5, and the sixth transistor T6, a first capacitor Cst, and a second capacitor Chold. One or more of the first transistor T1 to the sixth transistor T6 may be an oxide semiconductor transistor. For example, in one or more of the first transistor T1 to the sixth transistor T6, an active layer (or semiconductor layer) may include an oxide semiconductor layer. In one or more embodiments, one or more of the first transistor T1 to the sixth transistor T6 may be an N-type oxide semiconductor transistor.

A first electrode of the first transistor T1 (or driving transistor) may be connected to a second electrode of the sixth transistor T6, and a second electrode of the first transistor T1 may be connected to the second node N2. In addition, a first gate electrode of the first transistor T1 may be connected to a first node N1, and a second gate electrode (or back gate electrode) of the first transistor T1 may be connected to the second node N2. The first transistor T1 may control an amount of current supplied from the first driving power source VDD to the second driving power source VSS via the light-emitting element LD corresponding to a voltage of the first node N1.

The first transistor T1 may be formed as a double-gate transistor including a first gate electrode and a second gate electrode. When the second gate electrode is connected to the second node N2, a gate-source voltage of the first transistor T1 and a driving current may be stably maintained.

The second transistor T2 may be connected between the data line DLj and the first node N1. In addition, a gate electrode of the second transistor T2 may be connected to the first scan line SLi. The second transistor T2 may be turned on when an enable first scan signal GW (or high-level first scan signal GW) is supplied to a first scan line SL1i to electrically connect the data line DLj and the first node N1 to each other.

The third transistor T3 may be connected between the second node N2 and the third node N3. The second node N2 means a node to which the second electrode of the first transistor T1 and a first electrode of the third transistor T3 are electrically connected. The third node N3 means a node connected to the first electrode of the light-emitting element LD. A gate electrode of the third transistor T3 may be connected to a fourth scan line SL4i. The third transistor T3 may be turned on when an enable fourth scan signal GE (or high-level fourth scan signal GE) is supplied to the fourth scan line SL4i.

When the third transistor T3 is turned on, the second node N2 and the third node N3 may be electrically connected to each other, and accordingly, the first transistor T1 and the light-emitting element LD may be electrically connected to each other. When the third transistor T3 is turned off, the second node N2 and the third node N3 may be electrically blocked from each other, and accordingly, a current path through which the driving current can flow through the light-emitting element LD may be blocked.

The fourth transistor T4 may be connected between the third node N3 and the third power line PL3. In addition, a gate electrode of the fourth transistor T4 may be connected to a second scan line SL2i. The fourth transistor T4 may be turned on when an enable second scan signal GI (or high-level second scan signal GI) is supplied to the second scan line SL2i to electrically connect the third power line PL3 and the third node N3 to each other.

When the third power line PL3 and the third node N3 are electrically connected to each other, a voltage of the initialization power source VINT from the third power line PL3 may be supplied to the third node N3. Then, a parasitic capacitor equivalently formed in the light-emitting element LD is discharged, and accordingly, the black expression ability of the pixel PXij can be improved.

The fifth transistor T5 may be connected between the fourth power line PL4 and the first node N1. In addition, a gate electrode of the fifth transistor T5 may be connected to a third scan line SL3i. The fifth transistor T5 may be turned on when an enable third scan signal GR (or high-level third scan signal GR) is supplied to the third scan line SL3i to electrically connect the fourth power line PL4 and the first node N1 to each other. When the fourth power line PL4 and the first node N1 are electrically connected to each other, a voltage of the reference power source VREF may be supplied to the first node N1.

The sixth transistor T6 may be connected between the first power line PL1 and the first electrode of the first transistor T1. In addition, a gate electrode of the sixth transistor T6 may be connected to the emission control line ELi. The sixth transistor T6 may be turned off when a disable emission control signal EM (or low-level emission control signal EM) is supplied to the emission control line ELi, and may be turned on in other cases. When the sixth transistor T6 is turned on, a current path through which the driving current can flow through the pixel PXij may be formed.

The first capacitor Cst may be connected between the first node N1 and the second node N2. A voltage corresponding to a data signal may be stored in the first capacitor Cst.

The second capacitor Chold may be connected between the first power line PL1 and the second node N2. The second capacitor Chold may stabilize a voltage of the second node N2.

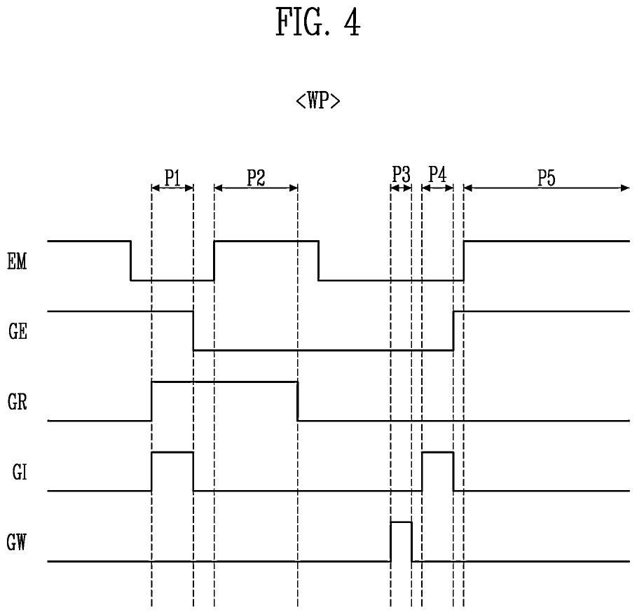

FIG. 4 is a diagram illustrating one or more embodiments of a method of driving the pixel shown in FIG. 3 during a write period WP. The write period WP may be included in an active area of a frame.

Referring to FIGS. 3 and 4, in the method of driving the pixel PXij, the write period WP may include a first period P1, a second period P2, a third period P3, a fourth period P4, and a fifth period P5.

The first period P1 may be a period in which the first capacitor Cst is initialized. The second period P2 may be a period in which a threshold voltage of the first transistor T1 is compensated. The third period P3 may be a period in which a voltage of a data signal is stored in the pixel PXij. The fourth period P4 may be a period in which the light-emitting element LD is initialized. The fifth period P5 may be a period in which the pixel PXij (or the light-emitting element LD) emits light.

During the first period P1, the enable second scan signal GI may be supplied to the second scan line SL2i, the enable third scan signal GR may be supplied to the third scan line SL3i, and the enable fourth scan signal GE may be supplied to the fourth scan line SL4i. In addition, the disable emission control signal EM may be supplied to the emission control line ELi.

When the disable emission control signal EM is supplied to the emission control line ELi, the sixth transistor T6 may be turned off. When the sixth transistor T6 is turned off, electrical connection between the first power line PL1 and the first transistor T1 may be blocked, and accordingly, the light-emitting element LD may be in a non-emission state.

When the enable second scan signal GI is supplied to the second scan line SL2i, the fourth transistor T4 may be turned on. When the fourth transistor T4 is turned on, the voltage of the initialization power source VINT may be supplied to the third node N3. When the enable fourth scan signal GE is supplied to the fourth scan line SL4i, the third transistor T3 may be turned on. When the third transistor T3 is turned on, the voltage of the initialization power source VINT of the third node N3 may be supplied to the second node N2.

When the enable third scan signal GR is supplied to the third scan line SL3i, the fifth transistor T5 may be turned on. When the fifth transistor T5 is turned on, the voltage of the reference power source VREF may be supplied to the first node N1. When the voltage of the reference power source VREF is supplied to the first node N1 and the voltage of the initialization power source VINT is supplied to the second node N2, the first capacitor Cst and the second capacitor Chold may be initialized. That is, the first period P1 may be a period in which the pixel PXij is initialized not to be influenced by a data signal supplied in a previous frame period.

During the second period P2, the supply of the disable emission control signal EM to the emission control line ELi may be suspended (or an enable (high level) emission control signal EM may be supplied), and the enable third scan signal GR may be supplied to the third scan line SL3i. The enable third scan signal GR supplied to the third scan line SL3i may be supplied during the first period P1 and the second period P2.

When the supply of the disable emission control signal EM to the emission control line ELi is suspended, the sixth transistor T6 may be turned on, and accordingly, the voltage of the first driving power source VDD may be supplied to the first electrode of the first transistor T1. When the enable third scan signal GR is supplied to the third scan line SL3i, the fifth transistor T5 may be turned on, and accordingly, the voltage of the reference power source VREF may be supplied to the first node N1.

The voltage of the reference power source VREF may be set such that the first transistor T1 can be turned on, and accordingly, the voltage of the second node N2 may be increased corresponding to a current supplied from the first transistor T1. The voltage of the second node N2 may be increased to a value obtained by subtracting an absolute threshold voltage of the first transistor T1 from the voltage of the reference power source VREF. That is, during the second period P2, a voltage corresponding to the threshold voltage of the first transistor T1 may be stored in the first capacitor Cst.

Meanwhile, a width of the second period P2 may be determined by a supply time of the enable emission control signal EM and/or a supply time of the enable third scan signal GR. That is, in one or more embodiments of the present disclosure, a compensation time of the threshold voltage of the first transistor T1 (e.g., the second period P2) may be controlled using the supply time of the enable emission control signal EM and the enable third scan signal GR.

During the third period P3, the disable emission control signal EM may be supplied, and accordingly, the sixth transistor T6 may be turned off. During the third period P3, the enable first scan signal GW may be supplied to the first scan line SL1i. When the enable first scan signal GW is supplied to the first scan line SL1i, the second transistor T2 may be turned on. When the second transistor T2 is turned on, a data signal from the data line DLj may be supplied to the first node N1.

During the third period P3, the voltages of the first node N1 and the second node N2 may be expressed as shown in Equation 1.

$$VN 1 = Vdata \qquad Equation 1$$

$$VN 2 = VREF - Vth 1$$

In Equation 1, Vdata may denote the voltage of the data signal, and Vth1 may denote the threshold voltage of the first transistor T1.

In Equation 1, for convenience of description, it has been described that the second node N2 maintains voltage VREF-Vth1 during the third period P3. However, the present disclosure is not limited thereto.

For example, during the third period P3, the first node N1 may be changed from the voltage of the reference power source VREF to the voltage Vdata of the data signal, and the voltage of the second node N2 may also be changed due to coupling of the first capacitor Cst. However, the voltage of the second node N2 is changed corresponding to a ratio of the first capacitor Cst and the second capacitor Chold, and accordingly, a voltage variation of the second node N2 can be reduced or minimized. After that, for convenience of description, it is assumed that the second node N2 maintains the voltage VREF-Vth1 during the third period P3.

During the fourth period P4, the supply of the disable emission control signal EM may be maintained, and the enable second scan signal GI may be supplied to the second scan line SL2i. When the enable second scan signal GI is supplied to the second scan line SL2i, the fourth transistor T4 may be turned on. When the fourth transistor T4 is turned on, the voltage of the initialization power source VINT may be supplied to the third node N3. When the voltage of the initialization power source VINT is supplied to the third node N3, the first electrode of the light-emitting element LD (or the parasitic capacitor of the light-emitting element LD) may be initialized to the voltage of the initialization power source VINT.

During the fifth period P5, the enable emission control signal EM may be supplied to the emission control line ELi. When the enable emission control signal EM is supplied to the emission control line ELi, the sixth transistor T6 may be turned on. When the sixth transistor T6 is turned on, the first power line PL1 and the first transistor T1 may be electrically connected to each other.

Also, during the fifth period P5, the enable fourth scan signal GE may be supplied to the fourth scan line SL4i. When the enable fourth scan signal GE is supplied to the fourth scan line SL4i, the third transistor T3 may be turned on. When the third transistor T3 is turned on, the second node N2 and the third node N3 may be electrically connected to each other.

The first transistor T1 may supply a driving current corresponding to the voltage of the first node N1 from the first driving power source VDD to the second driving power source VSS via the light-emitting element LD. Then, the light-emitting element LD may generate light with a luminance corresponding to the driving current during the fifth period P5. The fifth period P5 may be an emission period.

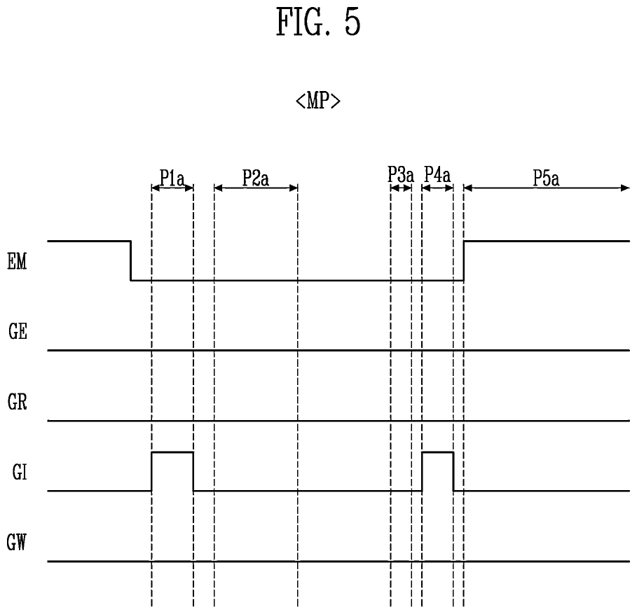

FIG. 5 is a diagram illustrating one or more embodiments of the method of driving the pixel shown in FIG. 3 during a maintenance period.

Referring to FIGS. 3 to 5, a frame period in accordance with one or more embodiments of the present disclosure may include one write period WP and at least one maintenance period MP.

The write period WP is a period in which a voltage of a data signal is stored in the pixels PX, the above-described driving signal shown in FIG. 4 may be supplied in the write period WP. That is, the write period WP may include the first period P1, the second period P2, the third period P3, the fourth period P4, and the fifth period P5, which are shown in FIG. 4, and the enable scan signals GW, GI, GR, and GE and the disable emission control signal EM may be supplied in each corresponding period (at least one period P1, P2, P3, P4, or P5).

The maintenance period MP is a period in which the pixels PX are in the non-emission state during a partial period while maintaining the data signal supplied in the write period WP. At least one maintenance period MP may be included in the frame period. When the maintenance period MP is included in one frame period, the pixels PX are in the non-emission state at a certain interval, and accordingly, moving image quality can be improved.

As shown in FIG. 5, the maintenance period MP may include a first period P1a, a second period P2a, a third period P3a, a fourth period P4a, and a fifth period P5a, which respectively correspond to the first period P1, the second period P2, the third period P3, the fourth period P4, and the fifth period P5, which are shown in FIG. 4.

During the first period P1a, second period P2a, the third period P3a, and the fourth period P4a of the maintenance period MP, the disable emission control signal EM may be supplied to the emission control line ELi. When the disable emission control signal EM is supplied to the emission control line ELi, the sixth transistor T6 may be turned off, and accordingly, the light-emitting element LD may be in the non-emission state during the first period P1a, second period P2a, the third period P3a, and the fourth period P4a.

In the first period P1a and the fourth period P4a of the maintenance period MP, the enable second scan signal GI may be supplied to the second scan line SL2i. When the enable second scan signal GI is supplied to the second scan line SL2i, the fourth transistor T4 may be turned on, and accordingly, the first electrode of the light-emitting element LD may be initialized to the voltage of the initialization power source VINT.

During the fifth period P5a of the maintenance period MP, the enable emission control signal EM may be supplied to the emission control line ELi. When the enable emission control signal EM is supplied to the emission control line ELi, the sixth transistor T6 may be turned on. When the sixth transistor T6 is turned on, the first power line PL1 and the first transistor T may be electrically connected to each other.

The first transistor T1 may supply a driving current corresponding to the voltage of the first node N1 from the first driving power source VDD to the second driving power source VSS via the light-emitting element LD. Then, the light-emitting element LD may generate light with a luminance corresponding to the driving current during the fifth period P5a.

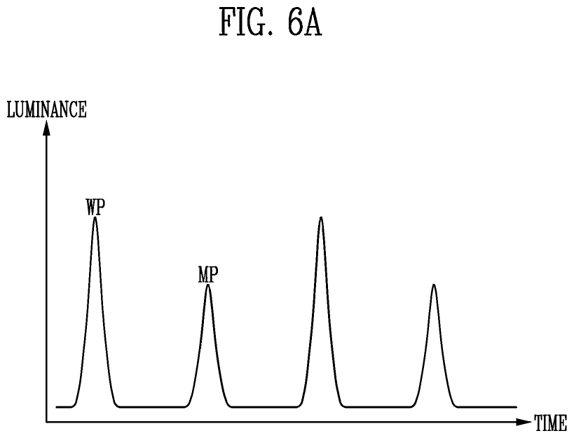

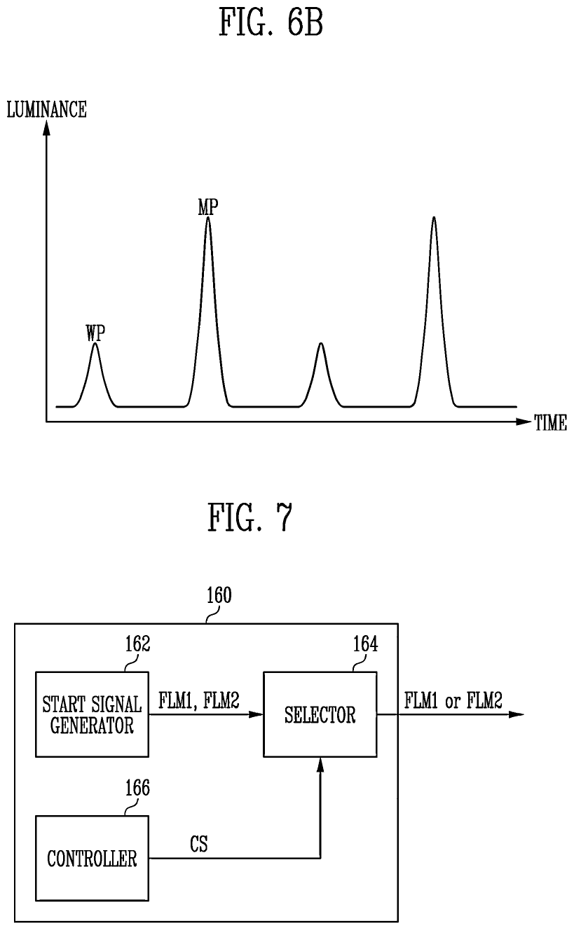

FIGS. 6A and 6B are diagrams illustrating luminances of the pixel during the write period and the maintenance period.

Referring to FIGS. 6A and 6B, luminances of the pixels PX may be different from each other during the write period WP and the maintenance period MP due to various causes. For example, during the write period WP, a voltage of a data signal may be supplied to the first node N1, and the second node N2 and the third node N3 may be initialized by the voltage of the initialization power source VINT. During the maintenance period MP, the voltage of the data signal may be maintained, and the third node N3 may be initialized.

A luminance difference may occur in the pixels PX during the write period WP and the maintenance period MP due to such a difference in driving method. For example, as shown in FIG. 6A, the pixels PX may generate light with a high luminance during the write period WP as compared with the maintenance period MP. For example, as shown in FIG. 6B, the pixels PX may generate light with a high luminance during the maintenance period MP as compared with the write period WP.

Luminances of the pixels during the write period WP and the maintenance period MP may be different from each other as shown in FIGS. 6A and 6B, and may correspond to a kind of panel (e.g., a resolution, a size, and the like), a process variation, a voltage of a power source (e.g., VREF or VINT) supplied to the panel, and the like. A luminance difference between the write period WP and the maintenance period MP may be recognized as a flicker.

FIG. 7 is a diagram illustrating a timing controller in accordance with one or more embodiments of the present disclosure. In FIG. 7, only components suitable for description of the present disclosure will be illustrated.

Referring to FIG. 7, the timing controller 160 in one or more embodiments may include a start signal generator 162, a selector 164, and a controller 166.

The start signal generator 162 may generate a first start signal FLM1 and a second start signal FLM2. The first start signal FLM1 may correspond to the disable emission control signal EM supplied during the write period WP, and the second start signal FLM2 may correspond to the disable emission control signal EM supplied during the maintenance period MP.

Widths of the first start signal FLM1 and the second start signal FLM2 may be set such that a luminance difference between the write period WP and the maintenance period MP can be compensated. For example, the widths of the first start signal FLM1 and the second start signal FLM2 may be set such that light with the substantially same luminance can be generated in the pixels PX during the write period WP and the maintenance period MP.

The selector 164 may supply the first start signal FLM1 or the second start signal FLM2 to the emission driver 140 corresponding to (e.g., based on) a control signal CS. For example, the selector 164 may output the first start signal FLM1 when a first level (or high level) control signal CS is input, and may output the second start signal FLM2 when a second level (or low level) control signal CS is input. The selector 164 may be a multiplexer.

The controller 166 may supply the first level control signal CS to the selector 164 during the write period WP, and may supply the second level control signal CS to the selector 164 during the maintenance period MP.

Meanwhile, it has been described that the selector 164 is included in the timing controller 160. However, the present disclosure is not limited thereto. For example, the selector 164 may be included in the emission driver 140.

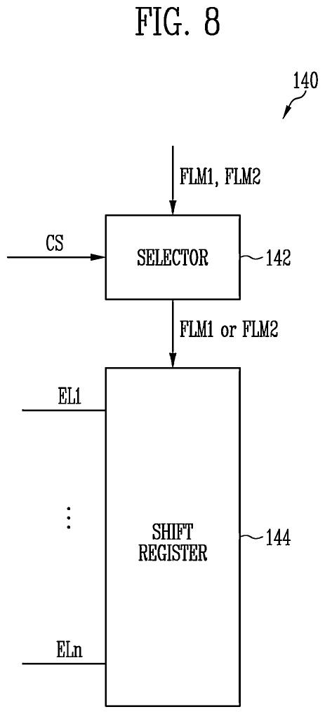

FIG. 8 is a diagram illustrating an emission driver in accordance with one or more embodiments of the present disclosure.

Referring to FIG. 8, the emission driver 140 may include a selector 142 and a shift register 144. When the selector 142 is included in the emission driver 140, the timing controller 160 may not include the selector 164. For example, the timing controller 160 may include only the start signal generator 162 and the controller 166.

The selector 142 may be supplied with the first start signal FLM1, the second start signal FLM2, and the control signal CS from the timing controller 160. The selector 142 may output the first start signal FLM1 when the first level control signal CS is input, and may output the second start signal FLM2 when the second level control signal CS is input.

The shift register 144 may be supplied with the first start signal FLM1 or the second start signal FLM2, and may sequentially supply, to the emission control signals EL1 to ELn, an emission control signal EM having a width corresponding to the first start signal FLM1 or the second start signal FLM2. To this end, the shift register 144 may be supplied with a clock signal, which is not shown from the timing controller 160.

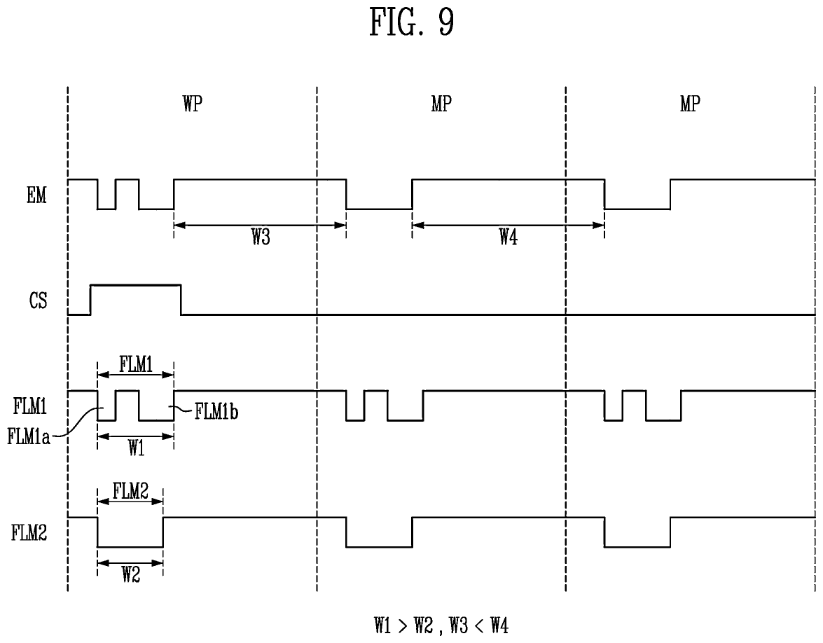

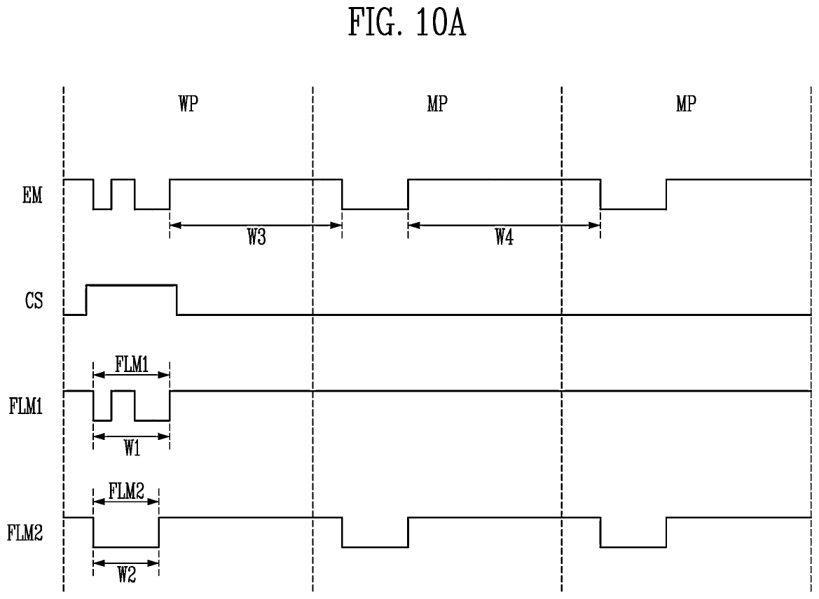

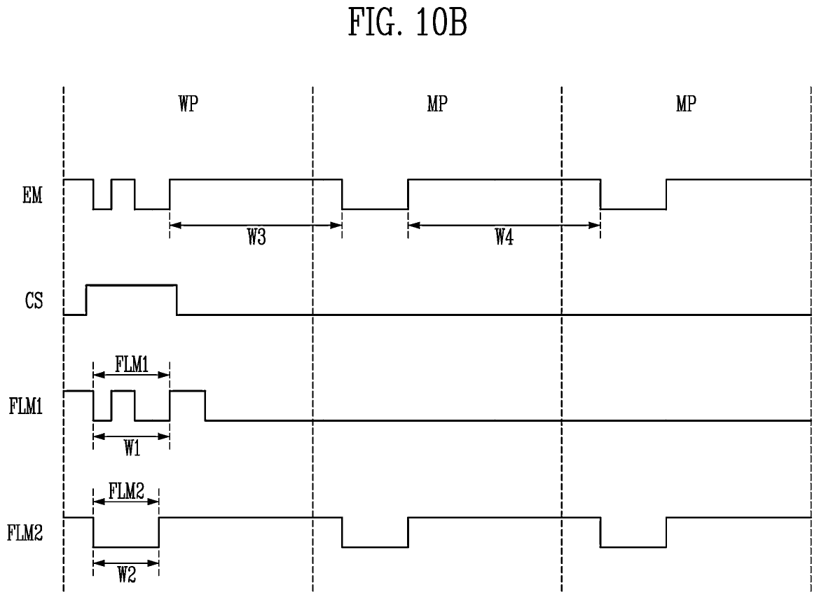

FIG. 9 is a diagram illustrating the first start signal and the second start signal when the write period is brighter than the maintenance period. FIGS. 10A and 10B are diagrams illustrating embodiments in which the first start signal is supplied. A luminance difference between the write period and the maintenance period may be pre-measured in a processing process, and widths of the first start signal FLM1 and the second start signal FLM2 may be pre-stored in the start signal generator 162 such that the luminance difference can be compensated.

Referring to FIG. 9, when the write period WP has a luminance higher than a luminance of the maintenance period MP at the same emission time, the emission time of the maintenance period MP may be increased as compared with the write period WP.

To this end, a width W1 of the first start signal FLM1 may be wider than a width W2 of the second start signal FLM2. When the width of the first start signal FLM1 is set as a first width W1, the pixel PX may be in the non-emission state by a period (or time) of the first width W1 during the write period WP. In addition, when the width of the second start signal FLM2 is set as a second width W2, the pixels PX may be in the non-emission state by a period of the second width W2 during the maintenance period MP.

Because the second width W2 is narrower than the first width W1, the emission time of the maintenance period MP may longer than the emission time of the write period WP. For example, the pixel PX may emit light by a period (or time) (or first emission period) of a third width W3 during the write period WP, and may emit light by a period (or second emission period) of a fourth width W4 during the maintenance period MP. The fourth width W4 may be wider than the third width W3, and accordingly, the pixels PX may emit light for a longer time during the maintenance period MP as compared with the write period WP.

When the pixels PX emit light for a longer time during the maintenance period MP as compared with the write period WP, a luminance difference between the write period WP and the maintenance period MP may be compensated. For example, the widths of the first start signal FLM1 and the second start signal FLM2 may be experimentally determined, such that luminances substantially equal to each other (or having a luminance difference in a threshold value (e.g., predetermined threshold value)) are generated during the write period WP and the maintenance period MP.

The first level control signal CS may be supplied during the write period WP, and the selector (142 or 164) may supply the first start signal FLM1 having the first width W1 to the shift register 144. Then, the shift register 144 may supply a disable emission control signal EM having the first width W1 to the emission control lines EL1 to ELn. The second level control signal CS may be supplied during the maintenance period MP, and the selector 142 or 164 may supply the second start signal FLM2 having the second width W2 to the shift register 144. Then, the shift register 144 may supply a disable emission control signal EM having the second width W2 to the emission control lines EL1 to ELn.

Meanwhile, the first start signal FLM1 may include a sub-first start signal FLM1a and a sub-second start signal FLM1b. The width W1 of the first start signal FLM1 may be to a time at which the supply of the sub-second start signal FLM1b is suspended (a high level voltage is supplied) after the sub-first start signal FLM1a is supplied (a low level voltage is supplied).

As described with reference to FIG. 4, because a low-level (or disable) fourth scan signal GE is supplied to the fourth scan line SL4i when the sub-first start signal FLM1a and the sub-second start signal FLM1b are supplied, the pixels PX may be in the non-emission state. In one or more embodiments, the width of the second start signal FLM1b is controlled, so that emission times of the pixels PX can be controlled during the write period WP.

Meanwhile, in FIG. 9, it is illustrated that the first start signal FLM1 is supplied even in the maintenance period MP. However, the present disclosure is not limited thereto.

For example, as shown in FIGS. 10A and 10B, the start signal generator 162 supplies the first start signal FLM1 only in the write period WP, and may not supply the first start signal FLM1 in the maintenance period MP. The start signal generator 162 may supply a high level voltage as shown in FIG. 10A, or a low level voltage as shown in FIG. 10B during a period in which the first start signal FLM1 is not supplied.

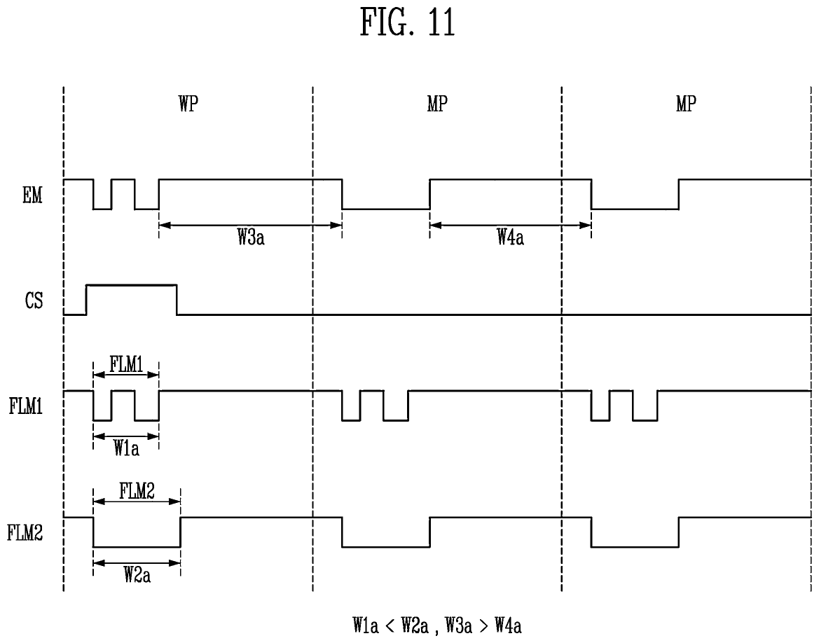

FIG. 11 is a diagram illustrating the first start signal and the second start signal when the maintenance period is brighter than the write period.

Referring to FIG. 11, when the maintenance period MP has a luminance that is higher than a luminance of the write period WP at the same emission time, the emission time of the maintenance period MP may be decreased as compared with the write period WP.

To this end, a width W1a of the first start signal FLM1 may be narrower than a width W2a of the second start signal FLM2. When the width of the first start signal FLM1 is set as a first width W1a, the pixel PX may be in the non-emission state by a period (or time) of the first width W1a during the write period WP. In addition, when the width of the second start signal FLM2 is set as a second width W2a, the pixels PX may be in the non-emission state by a period of the second width W2a during the maintenance period MP.

Because the second width W2a is wider than the first width W1a, the emission time of the maintenance period MP may be shorter than the emission time of the write period WP. For example, the pixel PX may emit light by a period (or time) of a third width W3a during the write period WP, and may emit light by a period of a fourth width W4a during the maintenance period MP. The fourth width W4a may be narrower than the third width W3a, and accordingly, the pixels PX may emit light for a short time during the maintenance period MP as compared with the write period WP.

When the pixels PX emit light for a short time during the maintenance period MP as compared with the write period WP, a luminance difference between the write period WP and the maintenance period MP may be compensated. For example, the widths of the first start signal FLM1 and the second start signal FLM2 may be experimentally determined such that luminances substantially equal to each other (or having a luminance difference in a threshold value (e.g., predetermined threshold value)) are generated during the write period WP and the maintenance period MP.

The first level control signal CS may be supplied during the write period WP, and the selector (142 or 164) may supply the first start signal FLM1 having the first width W1a to the shift register 144. Then, the shift register 144 may supply a disable emission control signal EM having the first width W1a to the emission control lines EL1 to ELn. The second level control signal CS may be supplied during the maintenance period MP, and the selector 142 or 164 may supply the second start signal FLM2 having the second width W2a to the shift register 144. Then, the shift register 144 may supply a disable emission control signal EM having the second width W2a to the emission control lines EL1 to ELn.

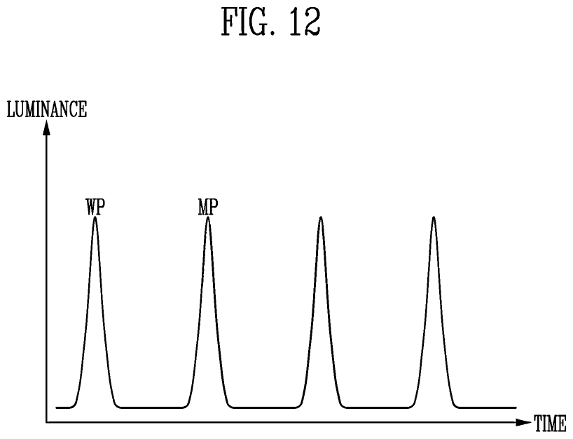

FIG. 12 is a diagram illustrating luminances of the write period and the maintenance period in accordance with one or more embodiments of the present disclosure.

Referring to FIG. 12, in one or more embodiments, the widths W1, W2, W1a, and W2a of the first start signal FLM1 and the second start signal FLM2 are controlled as shown in FIG. 9 or 11, so that the pixels PX can generate luminances substantially equal to each other (or having a luminance difference that is equal to or less than a threshold value) during the write period WP and the maintenance period MP. That is, occurrence of flickers can be reduced or minimized, and accordingly, display quality can be improved.

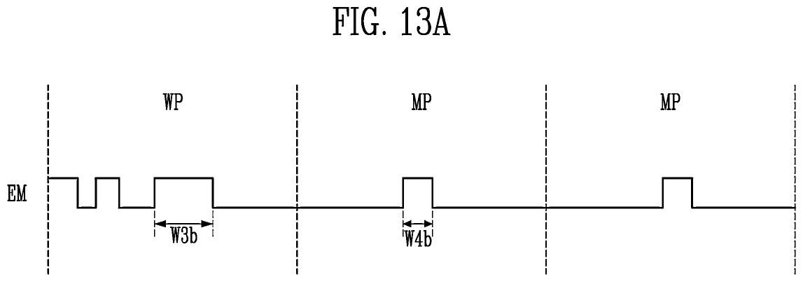

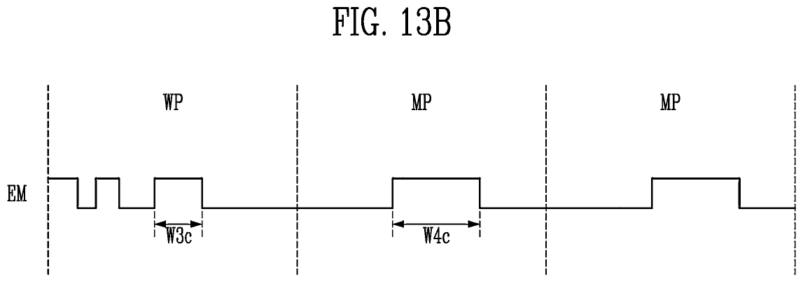

FIGS. 13A and 13B are diagrams illustrating an emission control signal in accordance with one or more embodiments of the present disclosure.

Referring to FIGS. 13A and 13B, in one or more embodiments of the present disclosure, the timing controller 160 may control the width of the emission control signal EM corresponding to a dimming level of the display device 100. The dimming level may include maximum luminance information on a maximum luminance that can be displayed in the pixel unit 110. The maximum luminance may be a luminance measured when the entire pixel unit 110 emits light with a maximum luminance set in the display device 100.

When the dimming level is low (e.g., when the maximum luminance is low), the timing controller 160 may set the emission times of the pixels to be relatively short using the start signals FLM1 and FLM2.

In one or more embodiments, when the luminance of the write period WP is low as compared with the maintenance period MP, corresponding to the same emission time as shown in FIG. 13A, the timing controller 160 may set the emission time of the maintenance period MP to be short as compared with the write period WP. For example, the pixels PX may emit light by the time of a third width W3b during the write period WP, and may emit light by the time of a fourth width W4b, which is shorter than the third width W3b, during the maintenance period MP.

In one or more embodiments, when the luminance of the maintenance period MP is low as compared with the write period WP, corresponding to the same emission time as shown in FIG. 13B, the timing controller 160 may set the emission time of the maintenance period MP to be long as compared with the write period WP. For example, the pixels PX may emit light by the time of a third width W3c during the write period WP, and may emit light by the time of a fourth width W4c, which is longer than the third width W3c, during the maintenance period MP.

That is, in the present disclosure, the luminance difference between the write period WP and the maintenance period MP can be similarly (or equally) maintained regardless of the dimming level.

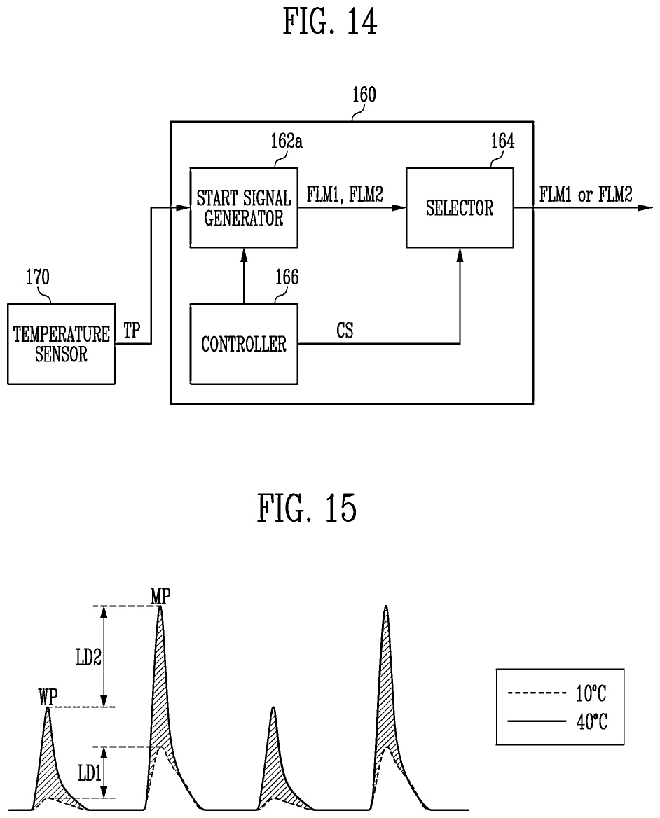

FIG. 14 is a diagram of a timing controller in accordance with one or more embodiments of the present disclosure. FIG. 15 is a diagram illustrating luminances corresponding temperatures of the display device.

In FIG. 14, components similar to those shown in FIG. 7 are designated by like reference numerals, and overlapping descriptions will be omitted.

Referring to FIG. 14, the timing controller 160 in one or more embodiments may include a start signal generator 162a, a selector 164, and a controller 166. In one or more embodiments, the selector 164 may be included in the emission driver 140.

In one or more embodiments, the display device may further include a temperature sensor 170. The temperature sensor 170 may sense a temperature of the display device 100 (or the pixel unit 110), and may supply a sensed temperature value TP to the start signal generator 162a.

The start signal generator 162a may change a width of at least one of the first start signal FLM1 or the second start signal FLM2 by reflecting the temperature value TP. The first start signal FLM1 may correspond to the disable emission control signal EM supplied during the write period WP, and the second start signal FLM2 may correspond to the disable emission control signal EM supplied during the maintenance period MP.

In one or more embodiments, the widths of the first start signal FLM1 and the second start signal FLM2 may be set such that the luminance difference between the write period WP and the maintenance period MP can be compensated. In one or more embodiments, the widths of the first start signal FLM1 and the second start signal FLM2 may be set such that the luminance difference between the write period WP and the maintenance period MP can be compensated corresponding to the temperature. For example, the widths of the first start signal FLM1 and the second start signal FLM2 may be set such that light with the substantially same luminance can be generated in the pixels PX during the write period WP and the maintenance period MP, regardless of the temperature.

For example, when the temperature of the pixel unit 110 is about 10° C. as shown in FIG. 15, the write period WP and the maintenance period MP may have a first luminance difference LD1 during the same emission period. In addition, when the temperature of the pixel unit 110 is about 40° C. as shown in FIG. 15, the write period WP and the maintenance period MP may have a second luminance difference LD2 that is different from the first luminance difference LD1 during the same emission period.

When the temperature value TP is not reflected on the first start signal FLM1 and the second start signal FLM2, which are generated by the start signal generator 162a, luminances of the write period WP and the maintenance period MP may be differently set corresponding to the temperature. To prevent this phenomenon, the start signal generator 162a may change the width of at least one of the first start signal FLM1 or the second start signal FLM2, corresponding to the temperature. For example, as the temperature increases, the changed width of the first start signal FLM1 and/or the second start signal FLM2 may be large. Then, the pixels PX may generate lights with luminances similar (or equal) to each other during the write periods WP and the maintenance period MP, regardless of the change in temperature of the display device 100.

In the display device and the method of driving the same in accordance with the present disclosure, a width of an emission control signal supplied in a write period, and a width of an emission control signal supplied in a maintenance period, are differently set, thereby reducing or minimizing a luminance difference between the write period and the maintenance period.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A display device comprising:
pixels connected to scan lines, data lines, and emission control lines;
a start signal generator configured to generate:
a first start signal corresponding to a first emission control signal supplied in a write period of a frame period, in which a data signal is supplied; and
a second start signal corresponding to a second emission control signal supplied in a maintenance period of the frame period, in which the data signal is maintained, and having a width that is different from a width of the first start signal;
a selector configured to supply the first start signal or the second start signal based on a control signal from a controller; and
an emission driver configured to supply the first emission control signal or the second emission control signal to the emission control lines based on the first start signal or the second start signal.

2. The display device of claim 1, wherein the first start signal comprises a sub-first start signal and a sub-second start signal, and
wherein a time at which supply of the sub-second start signal is suspended after the sub-first start signal is supplied is the width of the first start signal.

3. The display device of claim 1, wherein the selector is configured to supply the first start signal to the emission driver during the write period, and to supply the second start signal to the emission driver during the maintenance period.

4. The display device of claim 1, wherein the widths of the first start signal and the second start signal are set such that light is generated in the pixels during the write period and the maintenance period to have a luminance difference equal to or less than a threshold value.

5. The display device of claim 4, wherein the widths of the first start signal and the second start signal are set such that the pixels emit light for a longer time during the write period as compared with the maintenance period.

6. The display device of claim 4, wherein the widths of the first start signal and the second start signal are set such that the pixels emit light for a shorter time during the write period as compared with the maintenance period.

7. The display device of claim 1, further comprising a temperature sensor configured to sense a temperature of the display device,
wherein the start signal generator is configured to change a width of the first start signal or the second start signal.

8. The display device of claim 1, further comprising a timing controller configured to control the emission driver, and comprising the start signal generator, the controller, and the selector.

9. The display device of claim 1, wherein the emission driver comprises the selector.

10. The display device of claim 1, wherein a pixel among the pixels comprises:
a light-emitting element for generating light corresponding to an amount of current flowing from a first power line, to which a first electrode is connected, to a second power line, to which a second electrode is connected;
a first transistor connected between the first electrode of the light-emitting element and the first power line, and configured to control the amount of current corresponding to a voltage of a first node;
a second transistor connected between one of the data lines and the first node, and comprising a gate electrode connected to a first scan line;
a third transistor connected between the first transistor and the first electrode of the light-emitting element, and comprising a gate electrode connected to a fourth scan line;
a fourth transistor connected between the first electrode of the light-emitting element and a third power line to which an initialization power source is supplied, and comprising a gate electrode connected to a second scan line;
a fifth transistor connected between a fourth power line to which a reference power source is supplied and the first node, and comprising a gate electrode connected to a third scan line;
a sixth transistor connected between the first power line and the first transistor, and comprising a gate electrode connected to an emission control line;
a first capacitor connected between the first node and a second node as a common node between the first transistor and the third transistor; and
a second capacitor connected between the first power line and the second node, and
wherein the first transistor, the second transistor, the third transistor, the fourth transistor, the fifth transistor, and the sixth transistor comprise N-type transistors.

11. The display device of claim 10, wherein the first transistor comprises a first gate electrode connected to the first node, and a second gate electrode connected to the second node.

12. The display device of claim 1, wherein the start signal generator is configured to change the widths of the first start signal or the second start signal, corresponding to a dimming level.

13. The display device of claim 1, wherein the start signal generator is configured to supply the first start signal or the second start signal to the selector during the write period or the maintenance period.

14. The display device of claim 1, wherein the start signal generator is configured to:
supply the first start signal or the second start signal to the selector during the write period; and
supply the second start signal to the selector during the maintenance period.

15. A method of driving a display device, the method comprising:
supplying, by an emission driver, a first emission control signal based on a first start signal during a write period of a frame period in which a data signal is supplied; and
supplying, by the emission driver, a second emission control signal based on a second start signal for a maintenance period of the frame period in which the data signal is maintained,
wherein a first emission period of the write period, which corresponds to the first emission control signal, and a second emission period of the maintenance period, which corresponds to the second emission control signal, have different widths.

16. The method of claim 15, further comprising:
generating the first start signal and the second start signal;
supplying the first start signal to the emission driver during the write period, using a selector; and
supplying the second start signal to the emission driver during the maintenance period, using the selector.

17. The method of claim 15, wherein widths of the first start signal and the second start signal are set such that light is generated during the first emission period and the second emission period with a luminance difference equal to or less than a threshold value.

18. The method of claim 17, wherein the second emission period is longer than the first emission period.

19. The method of claim 17, wherein the first emission period is longer than the second emission period.

20. The method of claim 15, further comprising:
sensing a temperature of the display device; and
changing a width of the first start signal or the second start signal based on the temperature.
